(19) United States
(12) Patent Application Publication
(10) Pub. No.: US 2008/0164190 A1
(43) Pub. Date: Jul. 10, 2008

(54) Curbside gross pollution trap

(76) Inventors: David Pezzaniti, Flinder Park (AU); Timothy John Golding, Fairview Park (AU)

Correspondence Address: COLEMAN SUDOL SAPONE, P.C., 714 COLORADO AVENUE, BRIDGE PORT, CT, 06605-1601, US

(21) Appl. No.: 11/985,559

(22) Filed: Nov. 15, 2007

(30) Foreign Application Priority Data
Nov. 15, 2006 (AU) 2006906372

(51) Int. Cl. B01D 35/28

(52) U.S. Cl. 210/155; 210/154

(57) ABSTRACT

The gross pollution trap comprises an upper inlet portion directing stormwater through a filter inlet aperture to a filter chamber defining a filter flow path. The filter chamber is positioned in a lower portion of the trap. A filter is positioned in the filter flow path to collect debris from water flowing through the flow path. An outlet leads from the lower portion of the trap and in use is connected with a stormwater egress pipe. An overflow weir is locate in the upper portion of the trap is spaced above the filter inlet aperture, an water flowing over the weir spill into an overflow path ending at the outlet. The weir preferably has a return extending upstream from an upper portion of the overflow weir.

This invention relates to a gross pollution trap, and in particular to one suited to treating water run off from roads and other impervious areas.

### BACKGROUND OF THE INVENTION

Water from roads is diverted to the curbs of roads, which usually take the form of gutters. Water from gutters is diverted underground entering a gully pit either positioned beneath the footpath, or directly downwards of the gutter. The gully pit will typically extend below the invert level of the underground stormwater pipes that lead the water away from the gully pit, thereby facilitating collection of sedimentary debris. A grate may also be positioned across an entry to the gully pit in some cases to extend beyond the gutter and enhance the capacity to collect water in highflow rain events, which positioning of the grate has the added benefit of excluding larger articles of debris from entry to the gully pit.

A considerable amount of other debris enters the gully pit, including smaller particulate matter and organic liquids particularly oils that have collected on roadways, principally originating from motor vehicles. It may be desired that this material also is trapped so that it does not flow into and accumulate in the ultimate depositary of the stormwater which may be streams, lakes or other waterways.

A number of proposals have been made to provide filters to collect finer debris, and oil collection has been described using the provision of oil traps and absorbent materials or both, however there is a problem in providing filtration or capture of these pollutants in addition to the sedimentary debris whilst also taking into account high flow rain events, particularly where the filter is perhaps partially clogged, and whilst perhaps limiting the extent to which debris is released into the ultimate depositary of the storm water.

It is also a desirable that the works required for installation of water treatment facilities are kept to a minimum so that material and excavation effort are not more than required.

For the purposes of this specification the word “comprising” means “including but not limited to”, and the word “comprises” has a corresponding meaning. Also a reference within this specification to a document is not to be taken as an admission that the disclosure therein constitutes common general knowledge.

### SUMMARY OF THE INVENTION

In one broad form the invention could be said reside in a gross pollution trap comprising an upper inlet portion directing stormwater through a filter inlet aperture to a filter chamber defining a filter flow path with a filter to collect debris from water flowing therethrough, said filter chamber positioned in a lower portion of the trap, an outlet leading from the lower portion of the trap for connection with a stormwater egress pipe, and an overflow in the upper portion spaced above the filter inlet aperture leading to an overflow path ending at the outlet.

Preferably a lid is provided over the filter chamber, said lid having an opening defining the inlet aperture and being of smaller dimensions than the filter chamber, a pocket formed beneath a lower surface of the lid retains floatables when stormwater comes up to or over a level of the lid.

In one form the filter comprises a basket held in place in the filter chamber and the opening through the lid is of horizontal dimensions smaller than that of the basket. The lid may be removable separately to allow full access to the basket from above when the basket is in place in the filter chamber. Alternatively the lid may be fastened to the basket perhaps by removable fasteners particularly where the basket is removable so that the lid and the basket are removed together.

The opening through the lid is preferably at least about 200, 250, 300, 350 or 400 mm in diameter, more preferably between 250 to 350 mm and most preferably about 300 mm in diameter. Particularly with respect to a lid with dimensions of about 600 mm to 1 metre by about 500 to about 700 mm. This diameter is sufficient to cope with the majority of debris that is found in a street gutter, permits sufficient water flow to feed through to a standard stormwater egress pipe and also permits access by the standard vacuum pipe of an industrial mobile suction hose of, for example, the type used in a municipal council truck that has a diameter of about 150 mm to 200 mm. Such small openings relative to the overall lid dimensions assist also with maintaining floatable beneath the lid at high flow rain events. Preferably the opening through the lid is less than about 0.5, 0.45, 0.4, 0.35, 0.3, or 0.25 of the area of the lid. In addition the small opening has the benefit of tending to enhance the potential size of the pocket under the lid and thus the capacity for capture of floatables from the filter chamber. In preference the opening is positioned to one side of the main flow of stormwater. This offset position further reduces transmission of turbulence through the lid opening during high flow events.

In one form the lid slopes downward from a peripheral edge to an inside edge of the opening defining the filter chamber inlet aperture. The pocket is defined beneath the surface of the lid and thus is annular around the lid opening and is generally triangular in cross section. The shape of the lid, and as a result the pocket, can take many forms. Thus the lid may be generally flat with a downwardly depending flange at an inner edge thereof to thus form an annular pocket with a generally rectangular cross section.

Preferably the lid is downwardly sloping from a periphery to the opening so that stormwater runs off the lid and is thus not retained thereon after a rain event has finished. The slope also assists with the retention of float material in the collection chamber.

The overflow will typically comprise a wall extending upwardly of the filter chamber of the upper portion of the trap, to a level accommodating a high flow rain event, perhaps a one in three month event. This together with the hydraulic characteristics of the trap will determine the flow after which debris spills over the overflow and is no longer filtered.

In an important embodiment the overflow has a return facing the direction of the water flow. The return may comprise a generally horizontal roof like structure extending upstream from the overflow wall. The join between the return and the overflow wall is intended to not allow significant water flow therebetween, or a least to act to limit the volume of flow. The return acts to prevent water from climbing over the wall under the influence of the inertia of the water at intermediate flow rates. The return contains such climbing and consequently the overflow wall can be maintained at a lower level whilst effectively containing spill over at such an intermediate flow. This accordingly allows for a more vertically compact gross pollution trap arrangement within a road gully pit.

The overflow wall does not experience uniform flow across its length, typically high flow is experienced in just some portions such as those aligned directly with the flow of incoming stormwater, for example, those portions generally aligned with a gutter invert. Accordingly the return need also not be provided across all of the overflow wall, rather it may simply be provided over some of the wall that typically experiences greatest flow at intermediate flow events, however preferably it does extend across of the overflow wall. The return may be extended and thus be considered a hood. The hood may, for simplicity of construction, be generally planar and be fixed to the overflow wall, and the hood is preferably angled upwardly from the overflow wall, ending in a leading edge. The hood may, however, also be fabricated to be curved, and may for example be made from a moulded plastics material and fitted to the top of the overflow wall. Once incoming stormwater reaches the level of the leading edge, some will begin to spill over the overflow and will not be filtered.

The return may alternatively not extend all that much and be considered more a lip. Thus whilst the hood is anticipated to extend a considerable distance upstream the lip extends to a lesser degree. Thus for example where the overflow weir is approximately 100 mm high the lip extends a distance of about 20 mm upstream. The lip also inhibits water climbing over the overflow weir.

The effect of the return being either in the form of a hood or lip is enhanced further still where at least an upper part of the overflow weir, and preferably all of the weir, is angled in a downstream direction, or at least configured such that an acute angle is formed between the return and the overflow weir. The overflow weir might thus be angled at between 5 to 30° more preferably between 10 and 20° to the vertical.

The provision of a return over the entire length or portions of the overflow weir makes possible a reduction of the overall height of the overflow weir.

The trap preferably comprises an overflow chamber downstream of the filter chamber. In one form the filter chamber and the overflow chamber are formed from a unitary trap housing which is preferably separated by a dividing wall. Alternatively a bolt in frame may be provided to support the lid and overflow weir components. A flow-through opening located at a lower part of the filter chamber provides flow-through from the filter chamber to the overflow chamber and from there to the trap outlet leading into the stormwater egress pipe. An upper edge of the flow-through opening is preferably below the lower level of the trap outlet. The extent to which the upper edge is below the lower level of the trap outlet depends on the required capacity for retaining floatables during low to intermediate flow events. This position provides an oil entrapment region that at low to intermediate flow levels inhibits flow of floatables from the filter chamber through to the overflow chamber and thus out into the stormwater egress pipe. Thus in combination with the floatable pocket provided in the lid there are means for retaining floatable during low to high flow events to more effectively retain floatables.

It may also be desired to include an oil absorbable medium positioned in the filter chamber in the oil entrapment region. Where the lower portion of the basket is positioned in the oil entrapment region the oil absorbable medium may be position on the upper surface of the floor of the basket. Thus on lifting the basket out of the filter chamber a majority of the oil or other organic material will also be lifted.

The trap preferably includes a sump in a lowermost portion of the trap being below the flow through opening between the filter chamber and the overflow chamber. The sump is aligned beneath the filter chamber and collects sinkables such as grains of sand and other material that is denser than water that enters through the filter inlet aperture.

Preferably the filter means which typically will be in the form of a mesh basket is positioned spaced above the filter flowpath outlet and above a lowermost part of the trap outlet so that debris captured by the basket is not soaked with oil. Alternatively a rigid cage on the bottom of the filter chamber may support the filter means.

The filter or mesh may be a fabric that may be collapsible with a pore size chosen to be effective, alternatively it may be a plastics formed in a woven or non woven manner with pores of effective size. Alternatively it could be a metal grid perhaps of stainless steel to avoid problems associated with corrosion. If made of metal the filter may be an expanded mesh being expanded to an array of lands defining an array of pores, each of the lands being angled relative to the plane of the mesh so that the pores all face towards one edge of the mesh, and in the baskets the mesh is positioned so that the pores are substantially all angled downwardly thereby minimising the clogging of the pores. Alternatively a similar structure can be formed of plastics.

Preferably a lowermost portion of the filter basket has a releasable floor, that is conveniently hinged at one side and has a catch or other fastener at an opposite side. So that on lifting the basket the catch can be released to hinge open the floor and thereby release the trapped pollution.

The trap is also preferably provided with a grille preferably upstream of the upper portion. In one form this extends out from the gutter and thus enhance water collection ability particularly in high flow events, and in any event acts to prevent entry by large items of debris.

Preferably the filter basket is removable from the trap, on removal of the grill where on exists, by lifting it upwardly. Suitable shackles may be provided at sides of the basket. The filter basket may be returned to its position there being provided filter basket locating means to locate the basket in place. The filter basket may thus have one or more radially extending protrusions, which may for example be a radially extending flange to come to rest on a corresponding ledge in the wall of the filter chamber.

The sump may be provided with a removable tray to facilitate cleaning. In one form the tray could perhaps be linked to the basket so that it can be lifted at the same time the basket is removed from the trap for cleaning.

In an alternate aspect the invention might be said to reside in an arrangement for filtering curbside stormwater comprising of a gross pollution trap of any one or more of the forms set out herein set in a gutter. It is to be understood that the arrangement may have applications other than use simply for curbside stormwater filtration. Preferably wherein the filter aperture is offset from the flow of stormwater at high flow rain events.

In a further alternate aspect the invention might also be said to reside in a method of fitting a gross pollution trap to a gully pit leading off from a gutter and to a stormwater egress pipe.

For a better understanding illustrated embodiments of the invention will now be described with reference to the accompanying drawings wherein

### BRIEF DESCRIPTION OF THE DRAWINGS

FIG. 1 is a schematic view from above of the first illustrated embodiment,

FIG. 2 is a schematic cross sectional view through II-II of FIG. 1,

FIG. 3 is a schematic cross sectional view through III-III of FIG. 1,

FIG. 4 shows a second illustrated embodiment with an alternate arrangement particularly with regard to the configuration of the weir,

FIG. 5 is a plan view from above of a third embodiment of the invention,

FIG. 6 is a cross sectional view through VI-VI of FIG. 5, and

FIG. 7 is a cross sectional view through VII-VII of FIG. 5.

### DETAILED DESCRIPTION OF THE ILLUSTRATED AND EXEMPLIFIED EMBODIMENTS OF THE INVENTION

The gross pollution trap (1) of the present invention may be used receive stormwater from a gutter (2) which is shown in the illustrated embodiment to include a street level invert (3) which drops down to a lead-in invert (4), the lead in invert being covered by a flat cover (5).

The gross pollution trap comprises an upper inlet portion (10) directing stormwater through a filter inlet aperture (11) to a filter chamber (12) positioned in a lower portion of the trap. A filter (13) in the form of a filter basket is positioned in the filter chamber to collect debris from water flowing therethrough. An outlet (14) of the trap is connected with a stormwater egress pipe (14b). An overflow weir (15) is positioned in the upper portion.

A lid (16) is positioned over the filter chamber, the lid has an opening defining the filter inlet aperture (11). It can be seen that the lid slopes downwardly from a periphery to the opening. In the first illustrated embodiment this effectively forms an annular pocket (17) below the lower surface of the lid in conjunction with walls of the filter chamber. The pocket as shown schematically in FIG. 2 retains floatables (18) during intermediate and high flow events, where storm water in the filter chamber reaches the level of the lid. An enhancing feature may include a sleeve that extends below the opening by a short distance of 50 mm to 200 mm.

The opening through the lid is small relative to both the lid and the filter chamber. In the illustrated embodiment the opening is circular with a diameter of 300 mm. The dimensions of the rectangular lid are about 600 mm by about 850 mm, whereas the dimensions of the filter chamber are about 600 by about 900 mm. The filter chamber is approximately 500 deep. It is to be noted however that these dimensions will vary considerably depending on the particular use to which the gross pollution trap is put.

The opening is large enough to allow the hose pipe of a vacuum device of a municipal truck pass through should it be desired to clean debris out of the filter in that way. Additionally it is large enough to allow the vast majority of debris recoverable from paved roads to pass therethrough. The opening is small, however, relative to the surface of the lid and the size of the filter chamber and thus acts as a baffle to reduce the transmission of turbulence therethrough.

It can also be seen that the opening of the lid is offset considerably from the general direction of flow of stormwater via the lead-in invert (4) as shown by arrow (20) and thus the energy of the full flow of water through the lead-in invert is not encountered directly.

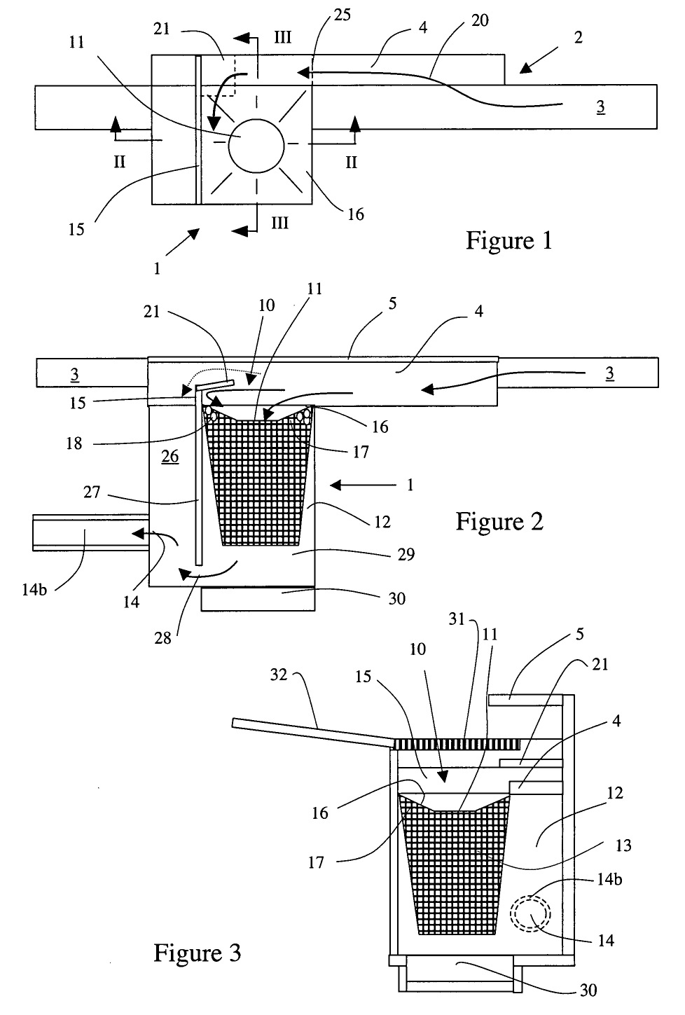

The overflow comprises a weir (15) which extends over the filter chamber and the lead-in invert (4). The wall is set at a level relevant to the location at which the trap is to be installed. It may thus be desired to provide for overflow of a one in three month rain event. Extending from an upper edge of the overflow weir in an upstream direction is a return which in this embodiment takes the form of a hood (21). The hood is angled upwardly in the upstream direction. As can be seen in FIGS. 1 and 3 the hood does not extend across all of the overflow, but simply in the region most likely to encounter strong flows being at and adjacent the lead-in invert (4). Water in regions of strong flows has a tendency to climb up a wall, and thus the provision of a hood (or a weir)) caps the climb up effect. The benefit of the hood is to allow the wall to be built more compactly, and thus more readily fit within existing constraints of a gully pit if so desired or at very least to reduce the depth of a pit that needs to be dug to accommodate the pollution trap.

There is a preferred clearance between the top of the weir and hood to the cover (5) or grille (31) that allows a plastic soft drink bottle to pass, because these tend to be the largest diameter floatable that is collected during rain events, and unless they can pass over the weir they tend to clog up the workings of the trap.

The trap is made from a unitary trap housing, being rectangular in shape. The trap housing is divided into the filter chamber (12) and an overflow chamber (26) by a dividing wall (27). Water spilling over the overflow falls into the overflow chamber, and from there passes directly into the outlet.

The filter chamber (12) communicates with the overflow chamber via a flow-though opening (28) at a lowermost part of the filter chamber. At low and intermediate flow rates stormwater flows though the opening in the lid, is filtered by the filter, passes through the flow-through opening (28) and out of the trap outlet (14) through to the stormwater egress pipe (14b).

It can be seen that an uppermost edge of the flow through opening is below the lower level of the trap outlet. That means that floatables within the filter chamber are inhibited from flowing through the oil entrapment region (29), at low flow events or when flows are not exhibited. The diversion of flow laterally by the weir creates a vortex flow condition above the lid. The condition prevents the creation of stagnant flow points and potential for build up of pollutants on the lid.

A sump (30) is formed as a pit beneath the filter chamber and specifically beneath the filter. This acts to collect sinkables, that is material such as sand that is heavier than water. This therefore reduces the risk of the flow-through opening clogging up, and additionally provides for a localised depot for take up by, for example, a vacuum pump of a municipal truck.

A grille (31) is shown as being positioned over the trap above the inlet portion, generally in line with the road surface (32). This allows for water run off from the road and provides access to the trap from above. The grille is support by a frame that is typically used for such grilles. The basket of the present invention is a rigid mesh basket with a removable floor, although it may also be made of fabric with or with out no removable floor. Periodically therefore the basket can be lifted out of the trap, after the grille is first removed. Once out of the trap the basket can be held above a receptacle for debris, the floor can be opened and the debris thus removed. The basket can be returned to the trap once the floor is secured again. Where fabric is used, the basket may be emptied or replaced with one that is already empty.

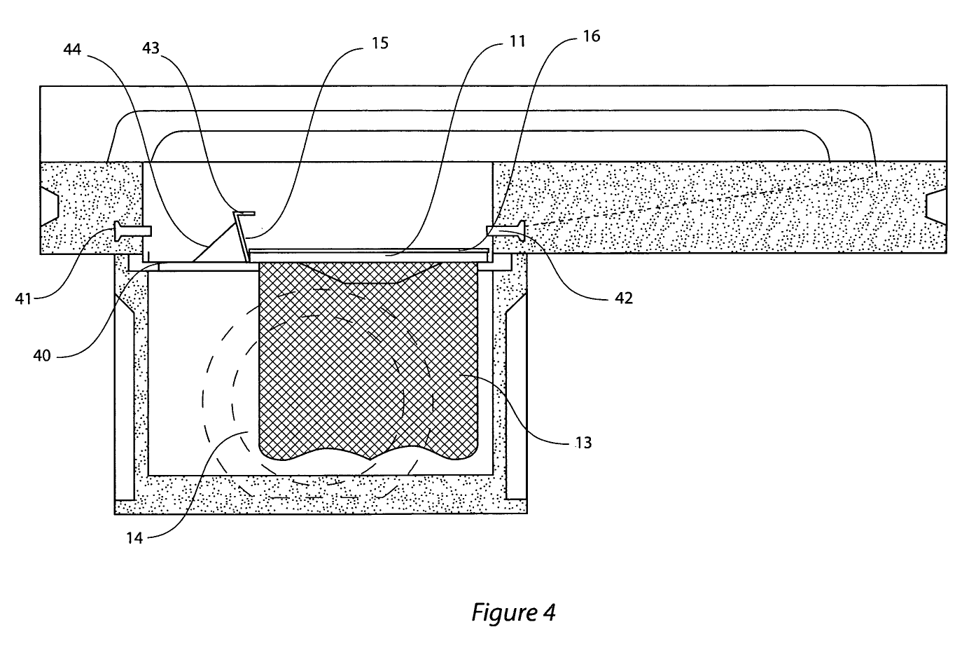

A second embodiment of the invention is shown in FIG. 4. Shown is a cross sectional view somewhat like FIG. 2. As can be seen a frame (40) bolted in place by bolts (41, 42) supports the lid (11) overflow weir (15), and acts as a support from which the filter basket (13) can be suspended. This embodiment has no dividing wall separating the filter chamber from the overflow chamber as does the first illustrated embodiment and therefore does not have the same capabilities in retention of floatables.

Additionally this embodiment has no hood, but instead has a lip (43) extending in an upstream direction from the top of the overflow weir (15). The height of the overflow weir is about 100 mm and the lip extends 20 mm therefrom. The overflow weir as can be seen is angled in a downstream direction and as shown the angle is about 15°. A brace (44) supports the overflow weir in place against the stormwater flow. It may also be noted that the lip is out of the way to facilitate removal of the basket for cleaning. It will also be noted that the basket does not have a removable floor but is made of fabric, and thus emptying is by inversion of the basket. The second embodiment also has no sump and thus together with the lower weir required by reason of provision of the lip, this trap for the comparable basket size requires less excavation than the first embodiment.

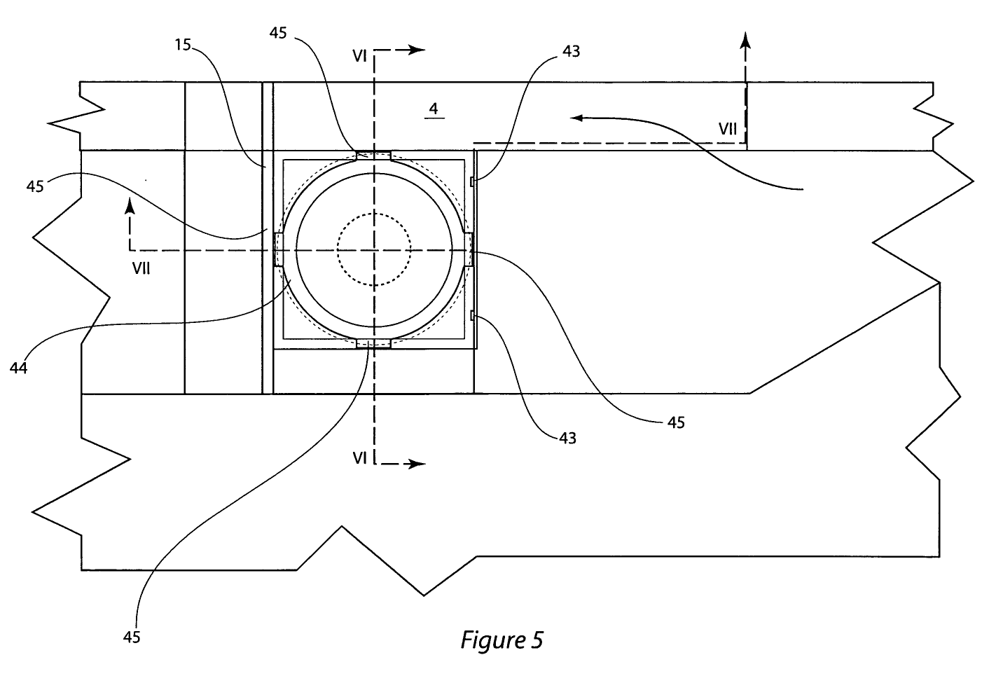

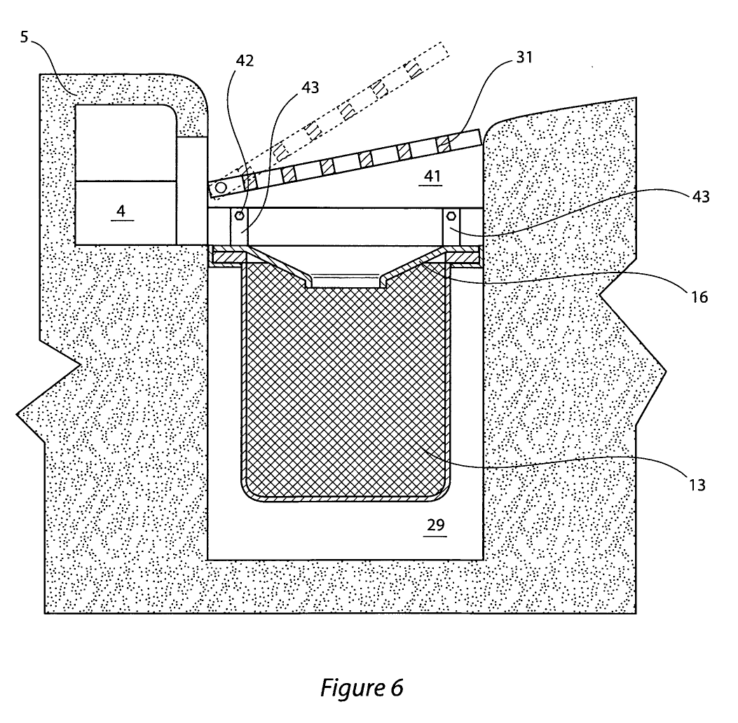

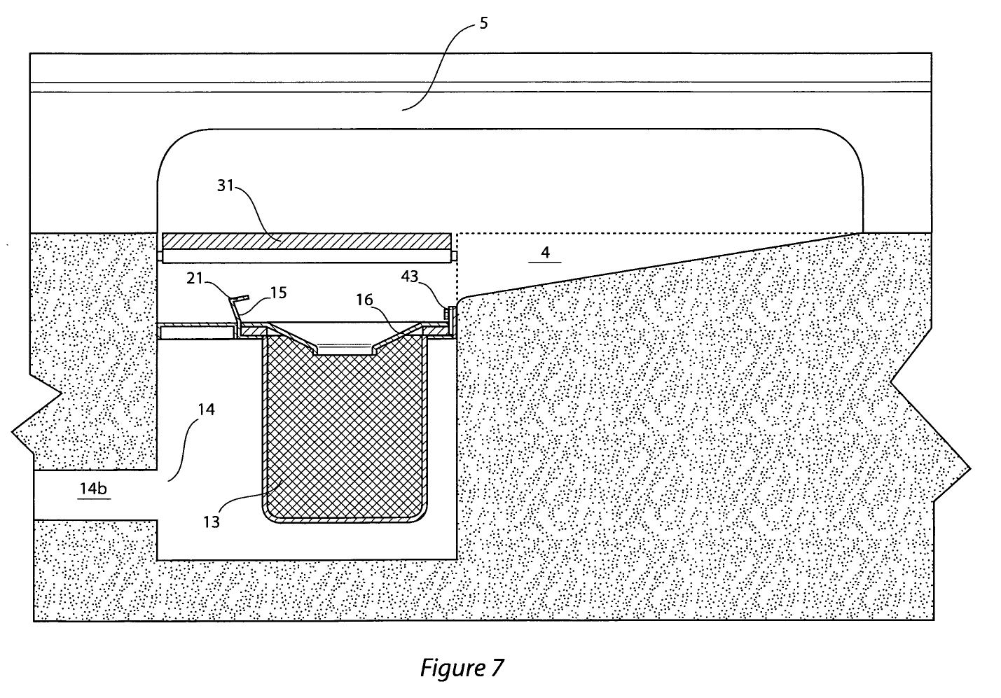

A third illustrated embodiment is shown in FIGS. 5, 6 and 7. This embodiment is similar in construction to that shown in FIG. 4, in that there is no vertical wall dividing the lower part of the trap into a filter chamber and overflow chamber, and has no sump.

Detail is shown of the manner in which the basket and rid is retained in the trap. Thus a generally square frame (40) is fastened to walls of the trap by bolts (41, 42) passing through brackets (43). The square frame is preferably of angled cross section and provides a seat.

The basket comprises an annular basket flange (44) extending outwardly from a top of the basket. The annular basket flange (44) comprises four lands (45) that fit over the square frame and are supported stably by the seat provided by the square frame.

The lid may be made of a polymeric material such as a plastics or composite thereof for example fibreglass, and is fitted on top of the annular basket flange, within the square frame 40.

What is claimed is:

1. A gross pollution trap comprising an upper inlet portion directing stormwater through a filter inlet aperture to a filter chamber defining a filter flow path having a filter positioned therein to collect debris from water flowing therethrough, said filter chamber positioned in a lower portion of the trap, an outlet leading from the lower portion of the trap for connection with a stormwater egress pipe, and an overflow weir in the upper portion of the trap, spaced above the filter inlet aperture leading to an overflow path ending at the outlet.

2. The gross pollution trap of claim 1 comprising a return extending upstream from an upper portion of the overflow weir.

3. The gross pollution trap of claim 2 wherein the return is angled upwardly from the overflow weir, ending in a leading edge, above an uppermost level of the weir

4. The gross pollution trap of claim 3 wherein the weir is angled in a downstream direction so that an upper part is further downstream than a lower part.

5. The gross pollution trap of claim 2 comprising a lid positioned over the filter chamber, said lid having an opening defining the inlet aperture and being of smaller dimensions than the filter chamber.

6. The gross pollution trap of claim 5 wherein the opening is positioned to one side of the main flow of stormwater, which flow is diverted to enter the filter chamber.

7. The gross pollution trap of claim 5 wherein the lid slopes downward from a peripheral edge to an inside edge of the opening defining the filter chamber inlet aperture.

8. The gross pollution trap of claim 5 wherein the opening is circular and between about 250 mm and 350 mm in diameter.

9. The gross pollution trap of claim 2 comprising an overflow chamber downstream of the filter chamber.

10. The gross pollution trap of claim 9 wherein the filter chamber and the overflow chamber are formed from a unitary trap housing separated by a dividing wall, said dividing wall together with said lid forming a pocket beneath a lower surface thereof to retain floatables when stormwater comes up to or over a level of the lid.

11. The gross pollution trap of claim 9 comprising a flow-through opening located at a lower part of the filter chamber to provide flow-through from the filter chamber to the overflow chamber and from there to the trap outlet leading into the stormwater egress pipe.

12. The gross pollution trap of claim 10 wherein an upper edge of the flow-through opening is below the lower level of the trap outlet.

13. The gross pollution trap of claim 12 including a sump in a lowermost portion of the trap being below the flow through opening between the filter chamber and the overflow chamber said sump being aligned beneath the filter chamber to collect sinkables that enter through the filter inlet aperture.

14. The gross pollution trap of claim 13 wherein the filter means is positioned spaced above the filter flowpath outlet and above a lowermost part of the trap outlet so that debris captured by the basket is not soaked with oil.

15. The gross pollution trap of claim 2 wherein the filter means is a mesh basket extending downwardly from the filter inlet aperture.

16. The gross pollution trap of claim 15 comprising a grille upstream of the upper portion to filter gross debris from the storm water before it enters the filter chamber.

17. The gross pollution trap of claim 16 wherein the grille is removable.

18. The gross pollution trap of claim 17 wherein the lid is removable to allow full access to the basket from above when the basket is in place in the filter chamber.

19. The gross pollution trap of claim 18 wherein the filter basket is removable from the trap by lifting it upwardly.

20. The gross pollution trap of claim 20 wherein the filter basket has one or more radially extending protrusions for support on a corresponding ledge relative to the filter chamber.
